(19) United States
(12) Patent Application Publication
(10) Pub. No.: US 2006/0101428 A1
(43) Pub. Date: May 11, 2006

(54) Compressing integrated circuit design data files

(76) Inventors: Anant Adke, Lake Oswego, OR (US); Gilduin Barre, Hillsboro, OR (US); Laurence W. Grodd, Portland, OR (US)

Correspondence Address: KLARQUIST SPARKMAN, LLP, 121 SW SALMON STREET, SUITE 1600, PORTLAND, OR, 97204, US

(21) Appl. No.: 11/272,201

(22) Filed: Nov. 9, 2005

Related U.S. Application Data
(60) Provisional application No. 60/626,897, filed on Nov. 10, 2004.

(51) Int. Cl. G06F 9/45

(52) U.S. Cl. 717/136; 716/3

(57) ABSTRACT

Described herein are methods for generating concise descriptions of an IC layout. The description from a first format is read and deciphered for determining any patterns in any repetition of elements of an IC layout. The repetitions are then expressed in a concise form to further compress the description. Duplicative information can be avoided by the use of these methods and systems. The repetition patterns described include row-type and column-type patterns. Some selected element instances may be described as part of a random-type arrangement of element instances instead of being described individually.

### CROSS REFERENCE TO RELATED APPLICATION

This application claims the benefit of U.S. Provisional application Ser. No. 60/626,897 filed Nov. 10, 2004, which is incorporated by reference herein.

### BACKGROUND

Integrated circuit (IC) designs are becoming increasingly complex as more and more processing capability is extracted from IC devices with smaller footprints. This trend has many implications for the technology related to design and fabrication of IC devices. For example, such complex circuits are more difficult to layout. Furthermore, generating concise and accurate descriptions of such layouts is more difficult. IC design engineers typically begin the process of designing an IC with a software description (e.g., in a programming language such as C) of the functionality of the circuit. Later, the software description of the design is synthesized to a hardware representation (e.g., a gate-level hardware representation) for fabrication as an IC.

Before fabrication, however, the hardware elements of an IC design are physically laid out along with descriptions of the interconnections between the elements of the circuit layout. Many performance factors can influence the placement of various IC elements within such a layout. For instance, a design engineer may choose particular placements in order to reduce the overall area (footprint) in silicon that will be occupied by a particular circuit. Other factors such as reducing the number of paths or wires needed to interconnect elements of a circuit may also influence the placement of elements within a layout.

Nevertheless, once the layout is finalized, the IC design, including a description of the associated layout, is transferred to an IC fabrication facility for manufacturing of the designed circuit. However, as noted above, since IC designs and associated IC layouts have become increasingly complex, data files associated with IC layout descriptions have tended to become larger as well. These larger files consume more computing resources and are more difficult to process. Thus, there is a need for methods and systems for generating descriptions of complex IC layouts that are concise, yet not lacking in the resolution and detail needed to fully describe the layout.

### SUMMARY

Described herein are methods and systems for generating compressed forms of IC layout descriptions. In one aspect, IC layout description data in a first format is parsed to determine whether instances of selected IC layout elements are repeated within the IC layout description. Such like-shaped or otherwise similar IC layout elements are then grouped into selected groups. Within each such group of repeated instances, the data related to the IC layout description in the first format is further analyzed to determine whether there is a pattern in the placement or location of the repeated instances of IC layout elements.

In a further aspect, a concise or a compressed description of an IC layout description in a second format can be generated by describing selected patterns in the placement of IC layout element instances. In another aspect, like-shaped or otherwise similar IC layout element instances within a particular cell are sorted into a group and then examined for any pattern in repetition. Likewise, in another aspect, such like-shaped or otherwise similar IC layout element instances belong to the same layer of the IC layout.

The IC layout elements can be cell structures or geometries within such structures, such as but not limited to, polygons, rectangles, circles, units of text and poly lines. In other aspects, the types of patterns may be of rows, columns, a diagonal arrangements and even random arrangements.

In another aspect, the IC layout description in a first format is parsed for first determining those like-shaped or otherwise similar IC layout element instances that are in a row-type arrangement and the description of the arrangement is written to file to yield a more compressed description of the IC layout in a second format. The IC layout description in the first format may then be further analyzed to determine those like-shaped or otherwise similar IC layout element instances that are in a column-type arrangement and the description of the column-type arrangement too can be written to file to yield a more compressed description of the IC layout in a second format. Furthermore, those other like-shaped or otherwise similar IC layout element instances that are not placed or located in either a row-type pattern or a column-type pattern may be described in the second format as a group of like-shaped IC layout elements arranged in a random type pattern to yield a more compressed description of the IC layout element. Alternatively, other like-shaped or otherwise similar IC layout element instances that do not form a row-type or column-type arrangement may be described individually.

Additional features and advantages will become apparent from the following detailed description of illustrated embodiments, which proceeds with reference to accompanying drawings.

### BRIEF DESCRIPTION OF THE FIGURES

FIG. 1 is a block diagram of an exemplary system for generating a compressed description of an IC layout.

FIG. 2 is a flow diagram of an exemplary overall method for generating a compressed description of an IC layout.

FIG. 3 is a block diagram illustrating an exemplary representation of repetition pattern types that may be used to generate a compressed IC layout description.

FIG. 4 is a flow diagram describing an exemplary method for determining the presence of repetition patterns in the placement of IC layout elements and representing such patterns to generate compressed IC layout descriptions.

FIG. 5 is a block diagram illustrating an exemplary client-server network environment.

FIG. 6 is a block diagram illustrating an exemplary method of generating compressed form of an IC layout description using a client-server network, such as the one illustrated in FIG. 5.

### DETAILED DESCRIPTION

The disclosed technology includes all novel and unobvious features and aspects of the embodiments of the system and methods described herein both alone, and in various combinations and sub-combinations thereof. The disclosed features and aspects of the embodiments can be used alone or in various novel and unobvious combinations and sub-combinations with one another.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms like “determine” to describe the disclosed methods. Such terms are high-level abstractions of the actual operations that are performed. The actual operations that correspond to these terms will vary depending on the particular implementation and are readily discernible by one of ordinary skill in the art.

Some of the methods described herein can be implemented in software stored on a computer-readable medium and executed on a computer. Some of the disclosed methods, for example, can be implemented as part of an electronic design automation (EDA) tool. Such methods can be executed on a single computer or a networked computer. For clarity, only those aspects of the software germane to these disclosed methods are described; product details well known in the art are omitted. For the same reason, the computer hardware is not described in detail.

IC layout descriptions can be provided in many different formats. The Graphic Data System II (GDSII) format is a popular format for transferring and archiving 2D graphical IC layout data. Among other features, it contains a hierarchy of structures, each structure containing layout elements (e.g., polygons, paths or poly-lines, circles and textboxes). The elements are situated on layers. Other formats include an open source format named Open Access, Milkyway by Synopsys, Inc., EDDM by Mentor Graphics, Inc., and the more recent, Open Artwork System Interchange Standard (OASIS) proposed by Semiconductor Equipment and Materials International (SEMI). These various industry formats can be used for describing the geometrical information related to describing an IC layout that can be used by fabrication facilities to manufacture the IC according to design. However, circuit designs represented using these conventional formats are not always concise.

For instance, in a typical IC design layout, many elements (e.g., cells, polygons and other shapes within cells) are repeated throughout. These repeated elements are referred to as different instances of the same element type. For instance, a cell comprising a particular arrangement of logic units may be repeated throughout an IC layout. Thus, these are multiple instances of the same cell element. Sometimes, placement or locations of such repetitions form one or more patterns or arrangements (e.g., a row, a column or a combination thereof. A more compressed form of an IC layout description can be achieved by describing these patterns or arrangements of various instances of IC layout elements instead of describing the placement of each element individually.

An Exemplary Overall System for Compressing IC Layout Descriptions

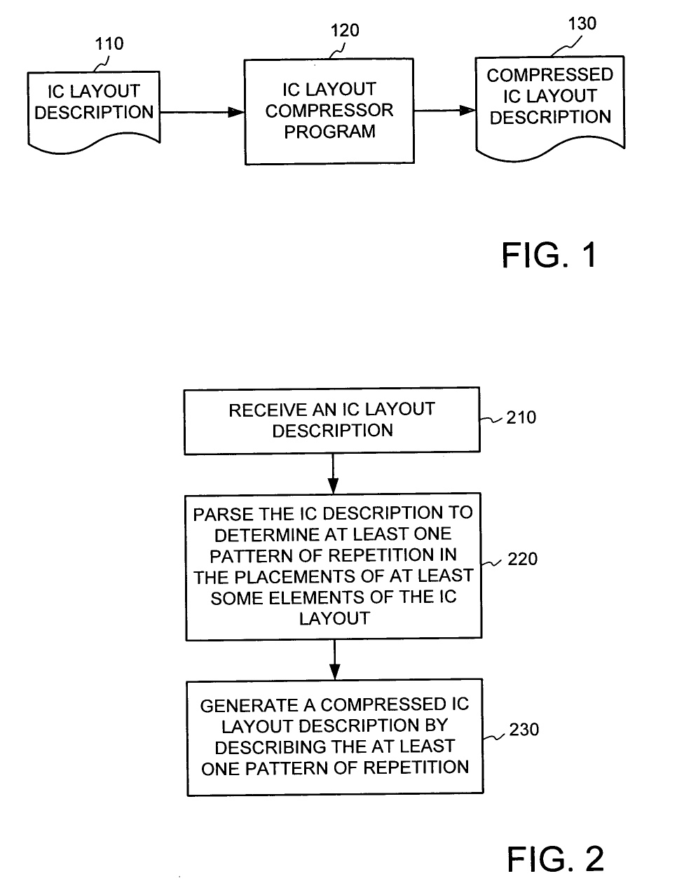

FIG. 1 illustrates an exemplary system for generating a compressed form of an IC layout description by converting an IC layout description in a first file format such as GDSII, Open Access, OASIS, EDDM and Milkyway. As shown in FIG. 1, an IC layout description 110 in a first format (e.g., GDSII, Open Access, OASIS, EDDM and Milkyway) may be provided to a compressor program 120, which converts the description from the first format to a more compressed description of an IC layout 130 in a second format.

An exemplary method for compressing IC layout descriptions FIG. 2 illustrates an overall method for generating a compressed version (e.g., 130) of an IC layout description from a first format (e.g., 110). According to the method in FIG. 2, at 210, a program (e.g., 120) operable for compressing an IC layout description receives an IC layout description in a first file format (e.g., 110). Then at 220, the IC layout description in a first format (e.g., 110) is parsed or otherwise deciphered to determine repetition patterns, if any, in the actual placement (or location) of the various instances of elements of an IC layout. Further at 230, a more compressed description of the IC layout can be generated by representing the determined repetition patterns instead of describing each and every instance of an IC layout element individually. A more compressed description may be generated by determining and describing at least one of the repetition patterns present in an IC layout. Each and every repetition pattern actually present in an IC layout need not be determined and if determined, need not be described to generate a more compressed or concise description of the IC layout. In fact, only selected patterns of repetition of elements of an IC layout need be described for generating a compressed description. For instance, this may be true because, in some cases describing a pattern of repetition may be less concise than describing each instance of an IC layout element individually.

### Exemplary Elements of an IC Layout

An IC layout (also referred to as objects) can comprise many different element types that can have unique characteristics including, but not limited to, geometrical and functional characteristics. Generally, an IC layout comprises multiple layers which become evident when an IC device is viewed from a cross-section perspective. Devices (e.g., a Nand gate) that form an IC can span across multiple layers. Furthermore, logical units of an IC may be organized as cell structures. Desirably, cell structures are named objects in a layout hierarchy. Cells can comprise instances of other cells and geometries such as polygons, trapezoids, paths, circles and other geometrical units.

Cells are desirably described at least in terms of a cell name and a placement or location within another cell. In general, the entire overall IC design may be thought of as the topmost cell in a hierarchy of cells that comprise other geometries (e.g., polygons). Cells may also be described in terms of their orientation. Different instances of the same cell type may be placed or located with different orientations (also referred to as angles of rotation or transformations).

Cells comprise geometries such as polygons, trapezoids, paths, circles and other geometrical units. In an IC layout description these geometries also need to be described. Rectangles are described in terms of their width, height and location or placement within a cell. The location or placement of a rectangle is typically described in terms of an x coordinate and a y coordinate of the lower left corner of the rectangle. Other polygons are desirably described at least in terms of an x coordinate and a y coordinate of a point of origin vertex and magnitude and direction of vectors related to other vertices. Any one of the multiple vertices of a polygon may be chosen to be its point of origin. Typically, a description of a polygon of n sides needs a description of n-1 vertices.

Lines connecting individual instances of elements of an IC layout are referred to as paths, poly lines or fat lines. Such paths are typically described much like a polygon geometrical unit described above. Circles are typically described in terms of a radius value and an x coordinate and a y coordinate location for the center of the circle. Furthermore, any other elements of an IC layout, including other geometries that are of interest to a fabricator of integrated circuits, can be described. For instance, text annotations can also be part of an IC layout. Text units are typically described in terms of a text string value and a placement or location information in terms of an x coordinate and a y coordinate.

As noted above, instances of IC elements such as a cell or a geometrical unit (e.g., a polygon) can be repeated. Such repetitions may form a pattern, a description of which can be used to generate a compressed form of the IC layout description.

### Exemplary Types of Repetition Patterns

Patterns of repetition themselves may follow a geometric pattern such as an array of IC layout elements arranged in form of a column, a row, some combination of rows and columns and other geometric patterns. The patterns may be patterns of repetition related to instances of IC layout elements such as cells or geometrical units (e.g., polygons, rectangles, trapezoids, paths and text). Nevertheless, in case of geometrical units within a cell, the patterns to be described for generating a compressed IC layout description are desirably patterns discernable within a particular cell and belonging on a particular layer of the IC. Also, desirably, any one pattern comprises instances of the same or like-shaped IC layout element.

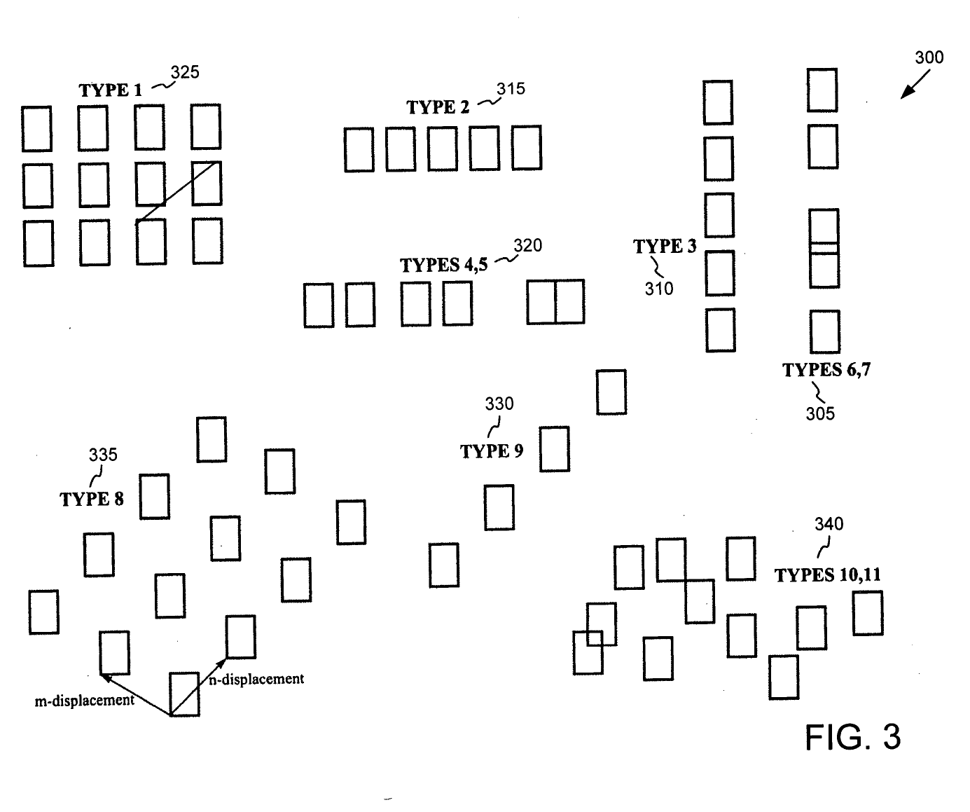

In one embodiment, the types of repetition patterns provided in OASIS can be used to describe a given IC layout. Other repetition pattern types may also be used. As shown in FIG. 3, OASIS format provides for repetition pattern types 1-11 (300). For instance, pattern type 3 at 310, types 6 and 7 at 305 are exemplary column-type patterns, whereas, type 2 at 315, types 4 and 5 at 320 are exemplary row-type patterns. Type 1 at 325 is an exemplary array type pattern with n columns and m rows. Type 8 at 335 and type 9 at 330 are exemplary diagonal arrangements of instances of like-shaped IC elements. Types 10 and 11 at 340 on the other hand, are arrangements of instances of the like-shaped IC layout elements that do not meet a particular type of geometrical shape or form. However, a group of such IC layout element instances may be described as random patterns of types 10 or 11, for instance, which may be more concise than describing each IC layout element instance individually.

These patterns may generally be referred to as pre-determined pattern types as described in OASIS. Other types may be added to the group illustrated in FIG. 3. Although FIG. 3 above illustrates using patterns or arrangement types using patterns or arrangements of rectangular shaped IC layout elements, any other type of IC layout element and patterns thereof can be similarly described. The repetition patterns determined in an IC layout can be represented using exemplary data as follows in table 1 below.

TABLE 1

| Type | Description Format |
|---|---|
| Type 1 | Type 1 is an N-column (N > 1) by M-row (M > 1) matrix with |
| | uniform horizontal and vertical spacing between the elements. |
| | x-dimension is N − 2 and y-dimension is M − 2. The |
| | (x-offset, y-offset) (cumulative spacing in the (horizontal, |
| | vertical) direction) of element (i, j) of the repetition |
| | (i = 0, . . . , N − 1 and j = 0, . . . , M − 1) |
| | is (i * x-space, j * y-space). |
| Type 2 | Type 2 is an N-column (N > 1) by 1-row vector with uniform |
| | horizontal spacing between the elements. X-dimension is |
| | N − 2. The (x-offset, y-offset) (cumulative spacing in |
| | the (horizontal, vertical) direction) of element is of the |
| | repetition (i = 0, . . . , N − 1) is (i * x-space, 0). |
| Type 3 | Type 3 is a 1-column by M-row (M > 1) vector with uniform |
| | vertical spacing between the elements. Y-dimension is |
| | M − 2. The (x-offset, y-offset) (cumulative spacing in |
| | the (horizontal, vertical) direction) of element j of the |
| | repetition (j = 0, . . . , M − 1) is (0, j * y-space). |
| Type 4 | Type 4 is an N-column (N > 1) by 1-row vector with |
| | (potentially) non-uniform horizontal spacing between the |
| | elements. X-dimension is N − 2. The (x-offset, y-offset) |
| | (cumulative spacing in the (horizontal, vertical) direction) |
| | of element i of the repetition (i = 0, . . . , N − 1) is |
| | (x-space 0 + . . . + x-space i, 0), with x-space 0 = 0. |
| Type 5 | Type 5 is identical to TYPE 4, except that all offset values |
| | must be multiplied by grid during expansion of the repetition. |
| Type 6 | Type 6 is a 1-column by M-row (M > 1) vector with |
| | (potentially) non-uniform vertical spacing between the |
| | elements. y-dimension is M − 2. The (x-offset, y-offset) |
| | (cumulative spacing in the (horizontal, vertical) direction) |
| | of element j of the repetition (j = 0, . . . , M − 1) |
| | is (0, y-space0 + . . . + y-space j), with |
| | y-space0 = 0. |
| Type 7 | Type 7 is identical to TYPE 6, except that all offset values |
| | must be multiplied by grid during expansion of the repetition. |
| Type 8 | Type 8 is an N (N > 1) by M (M > 1) repetition with uniform |
| | and (potentially) diagonal displacements between the elements. |
| | N-dimension is N − 2 and m-dimension is M − 2. |
| | Defining n-displacement in terms of its components nx-space |
| | and ny-space (and similarly for m-displacement), the |
| | (x-offset, y-offset) (cumulative spacing in the (horizontal, |
| | vertical) direction) of element (i, j) of the repetition |
| | (i = 0, . . . , N − 1 and j = 0, . . . , M − 1) |
| | is (i * nx-space + j * mx-space, i * ny-space + j * |
| | my-space). |
| Type 9 | Type 9 is a P-element (P > 1) repetition with uniform and |
| | (potentially) diagonal displacements between the elements. |
| | dimension is P − 2. Defining displacement in terms of its |
| | components x-space and y-space, the (x-offset, y-offset) |
| | (cumulative spacing in the (horizontal, vertical) direction) |
| | of element k of the repetition (k = 0, . . . , P − 1) |
| | is (k * x-space, k * y-space). |
| Type 10 | Type 10 is a P-element (P > 1) repetition with (potentially) |
| | non-uniform and arbitrary two-dimensional displacements |
| | between the elements. dimension is P − 2. Defining |
| | displacementk in terms of its components x-spacek and |
| | y-spacek, the (x-offset, y-offset) (cumulative spacing in |
| | the (horizontal, vertical) direction) of element k of the |
| | repetition (k = 0, . . . , P − 1) is (x-space0 + . . . + |
| | x-spacek, y-space0 + . . . + y-spacek) with |
| | x-space0 = y-space0 = 0). |
| Type 11 | Type 11 is identical to TYPE 10, except that all offset |
| | values must be multiplied by grid during expansion of the |
| | repetition. |

As noted above, describing a group of similar or like-shaped elements of an IC layout based on a discerned pattern of repetition is not always more concise than describing the elements within such a group individually. This may be so, at least in part because some of the data (as shown above) needed to describe the patterns of repetition may be less concise than the data needed to describe the elements individually. For instance, row-type patterns (e.g., type 2, type 4 and type 5) comprising less than three instances of an IC layout element cannot be expressed more concisely by describing types of patterns in their repetition. In fact, it may be better to describe these instances of IC layout elements individually. The same applies to a set of instances of an IC layout element repeated in a column-type pattern (e.g., type 3, type 6 and type 7).

### An Exemplary Method for Determining Patterns of Repetition in an IC Layout

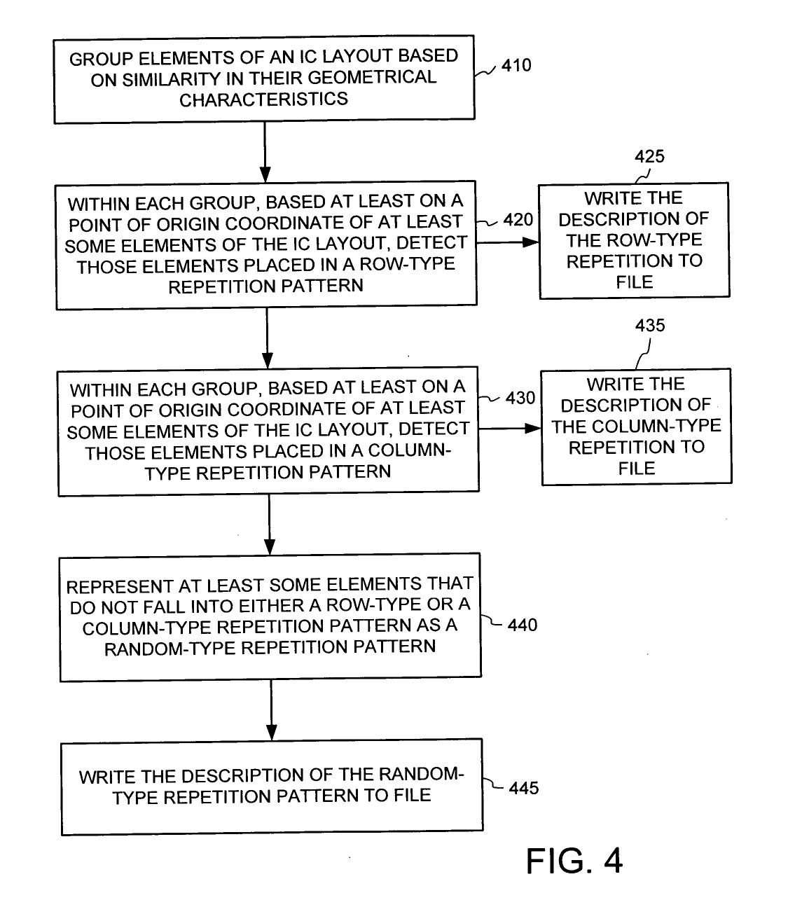

FIG. 4 describes an exemplary method for detecting repetition patterns in an IC layout description and generating a compressed description by representing the repetition pattern in a concise manner. At 410, data describing an IC layout is parsed to sort at least some of the elements of the layout with similar, and desirably identical, geometrical characteristics into selected groups. For instance, rectangles with similar, and desirably identical, width and height characteristics may be grouped together. Likewise, cell structures, and other geometries such as circles, trapezoids, and text may be grouped together.

In case of cell structures, the similarity of various cell instances grouped together in a selected grouping is desirably determined based on similarities of their characteristics including, but not limited to, their cell name and orientation. Thus, in one embodiment, cell instances that have different angles of orientation but are otherwise identical, are desirably not grouped together for determining a pattern in their repetition within an IC layout.

Whether polygons are similar or like-shaped can be determined, for example, by using the length data and direction data related to their respective vertices. In case of circles, similarity can be determined based on their radius data, for instance. Trapezoids may be treated in the same way as any other polygon. In case of text, the string value of the text field is compared, for instance.

Nevertheless, in one embodiment, instances of IC layout elements that are geometrically similar and related to a particular layer are desirably grouped together. For those IC layout elements that are within a cell, such as polygons, and other geometrical units, they are desirably grouped with other instances of similar geometrical characteristics within the same cell.

Furthermore, once geometrically similar, and desirably identical, instances of IC layout elements are grouped, at 420, their placement data (e.g., x and y coordinate location of a point of origin of a rectangle) is examined to determine whether a plurality of such layout element instances within a group are placed or located in a row-type repetition pattern (e.g., type 2, type 4 and type 5 of OASIS). If so, these element instances are desirably represented in the form of their row-type repetition pattern and written to file 425. For instance, in one embodiment, the repetition pattern may be expressed in terms of a row-type pattern data structure (e.g., type 2, type 4 and type 5 of OASIS). In one embodiment, only the row-type repetition patterns having more than two element instances arranged in a row-type pattern are expressed in the form of their respective repetition pattern types. Anything less in this embodiment may be ignored (e.g., individual descriptions may be used instead). This can, for example, be heuristically determined based on the nature of the data structure used to express the pattern of repetition. If the data structure is complex, it may consume more memory and other resources to describe a layout in terms of patterns of repetition than to express instances of elements of the IC layout individually. One factor in such a determination may be number of instances of a layout element that are repeated in a pattern.

Whether instances of layout elements form a row-type repetition pattern is desirably determined at least based on data associated with their placement or location data. In case of a rectangle, the y-coordinate of a selected corner of rectangular elements (point of origin) in a group are compared and, if they suggest a row-type arrangement, then they can be determined to form a row. Thus, for instance, consecutively placed element instances with similar y-coordinates suggest a row-type pattern and can be expressed as such.

Once element instances forming a row-type pattern are determined, at 430, element instances forming a column-type pattern are determined and described. Again in one embodiment, only repetition patterns comprising more than two elements instances are represented in the form of their repetition pattern for compression. To determine a column-type pattern of repetition of rectangular layout elements, in one desirable approach, the x- coordinates of a selected corner of the rectangular element instances in a group are compared. Then at 435, if their x-coordinate values are similar, these element instances are represented in the form of their column-type repetition pattern (e.g., type 3, type 6 and type 7 of OASIS) and written to a file. In other embodiments, the order of first determining a row-type pattern can be interchanged with determining column-type patterns first.

Regardless, at 440, those similarly shaped element instances that do not fall within either a row-type pattern or a column-type pattern may be expressed as belonging to a random-type repetition pattern (e.g., type 10 and 11 of OASIS). Thus, at 445 these descriptions are written to file.

The diagonal-type patterns (e.g., type 8 and type 9 of OASIS) can also be determined based on their placement or location coordinates (e.g., a selected vertex of a polygon). Alternatively, they can be expressed as a random-type pattern. With regard to expressing layout description using random-type patterns, one instance may be selected as a reference and the rest of the instances may be described in terms of displacement vectors from the reference instance or from a vertex of the reference instance. One way is to heuristically determine whether it is more concise to express a layout description in terms of a random-type arrangement of a group of element instances or in terms of locations of the instances individually. In another embodiment, the random-type arrangement is chosen for expressing a group of element instances comprising at least 3 instances.

### Exemplary IC Layout Descriptions Using Modality Information

In one further aspect, assume a repetition pattern is determined and further analysis of the geometric data of an IC layout yields another repetition of a similar type. In this case, instead of describing the repetition pattern data again, the new repetition pattern may be described on the basis of the previous repetition pattern using a modality information data structure such as type 0 of OASIS. The subsequent repetition patterns may be described with just the additional data that shows the differences in actual placement coordinates, for instance. In this manner, information that is identical for different repetition instances need not be unnecessarily duplicated. For instance, repetitions of a previously described column-type pattern may be described using modal data without the need to describe the pattern related data again.

### Exemplary Implementation in a Distributed Network Environment

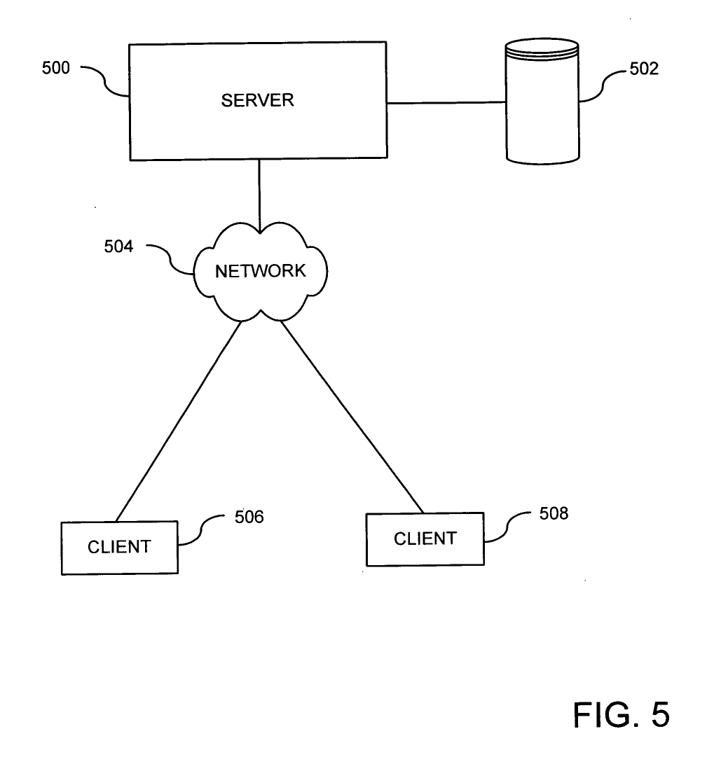

Any of the aspects of the technology described above may be performed or designed using a distributed computer network. FIG. 5 shows one such exemplary network. A server computer 500 can have an associated storage device 502 (internal or external to the server computer). For example, the server computer 500 can be configured to process EDA information related to circuit designs using any of the embodiments described above (e.g., as part of an EDA software tool). The server computer 500 may be coupled to a network, shown generally at 504, which can comprise, for example, a wide-area network, a local-area network, a client-server network, the Internet, or other such network. One or more client computers, such as those shown at 506, 508, may be coupled to the network 504 using a network protocol.

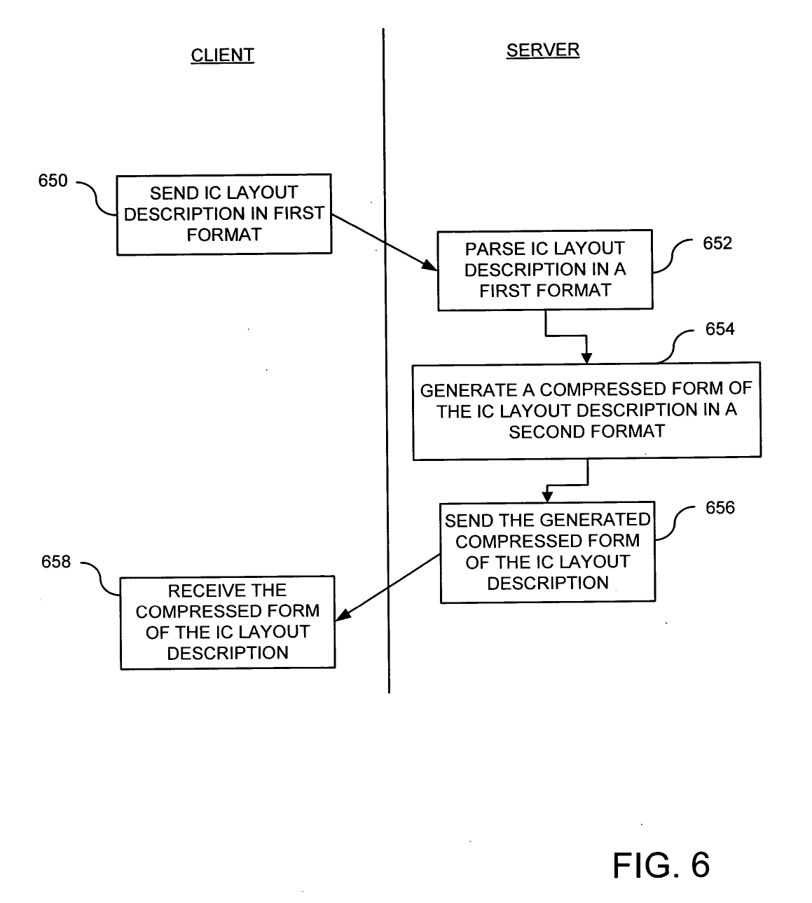

As shown in FIG. 6 at process block 650, for example, a client computer sends data related to EDA information. For instance, a client computer may send one or more proposed IC design layouts and other EDA information from a design database. In process block 652, the data is received and parsed and otherwise deciphered by the server computer according to any of the disclosed embodiments.

In process block 654, the IC layout description information is processed according to any of the disclosed embodiments. In process block 656, the server computer sends the results (e.g., a compressed form of the IC layout description in a second format) to the client computer (e.g., 506 and 508) which receives the information in process block 658. It should be apparent to those skilled in the art that the example shown in FIG. 6 is not the only way to compress the IC layout information and share the resulting compressed IC layout information. For instance, the client computer that sends the IC layout information may not be the same client that receives the results. Also, the IC layout information may be stored in a computer-readable media that is not on a network and that is sent separately to the server. Or, the server computer may perform only a portion of the design procedures.

Having described and illustrated the principles of our technology with reference to the illustrated embodiments, it will be recognized that the illustrated embodiments can be modified in arrangement and detail without departing from such principles. For example, only selected element instances may be sorted, grouped, and examined for repetition patterns in their placement. Furthermore, not every repetition identified in the placement of such elements may ultimately be written to file to generate a compressed IC layout description.

Also, many of the examples refer to types of patterns illustrated in OASIS. However, the principles and features are not limited to applicability in context of OASIS. Instead, additional pattern types and other data structures can be used in conjunctions with the principles and features described above.

Furthermore, elements of the illustrated embodiment shown in software may be implemented in hardware and vice-versa. In view of the many possible embodiments to which the principles of the technology may be applied, it should be recognized that the illustrated embodiments are examples of the technology and should not be taken as a limitation on the scope of the technology. For instance, various components of systems and tools described herein may be combined in function and use.

We claim:

1. A computer implemented method of translating an integrated circuit layout description from a first file format to a second file format, the method comprising:
based on the integrated circuit layout description in the first file format, determining at least one set of objects within the integrated circuit layout that are identical;
based on data associated with placement of the identical objects within the integrated circuit layout, identifying at least one pattern in the placement of the identical objects;
generating a description of the at least one pattern; and
using the description of the at least one pattern for generating the integrated circuit layout description in the second file format comprising the description of the at least one pattern.

2. The method of claim 1, wherein the integrated circuit layout as represented in the description in the second file format has fewer bits of data than the integrated circuit layout description in the first file format.

3. The method of claim 1, wherein the first file format is GDSII and the second file format is OASIS.

4. The method of claim 1, wherein the first file format is OpenAccess and the second file format is OASIS.

5. The method of claim 1 further comprising, determining whether the at least one pattern matches at least one predetermined pattern type and the description of the at least one pattern comprises data associated with identifying the predetermined pattern type.

6. The method of claim 5, wherein the predetermined pattern type is selected from a group consisting of OASIS pattern Type 0, Type 1, Type 2, Type 3, Type 4, Type 5, Type 6, Type 7, Type 8, Type 9, Type 10, and Type 11.

7. The method of claim 1, wherein at least some of the objects are in shape of a rectangle and the data associated with the placement of the rectangular polygons within the integrated circuit layout comprises one or more of coordinates of an origin of the rectangle, a width of the rectangle, and a height of the rectangle.

8. The method of claim 1, wherein at least some of the objects are in shape of a polygon and the data associated with the placement of at least some of the polygons within the integrated circuit layout comprises one or more of coordinates of origins of the at least some of the polygons, length data and direction data associated with vertices of at least some of the polygons.

9. A computer implemented method for representing an integrated circuit layout by recognizing patterns in placement of elements within the integrated circuit layout, the method comprising:
based on geometrical data describing the elements of the integrated circuit layout, identifying similar elements of the integrated circuit layout;
at least based on placement points of origin of at least some of the similar elements of the integrated circuit layout, identifying at least one set of the similar elements of the integrated circuit layout that form at least one column pattern;
generating a description of the at least one column pattern; and
using the description of the at least one column pattern to generate a description representing the integrated circuit layout.

10. The method of claim 9 further comprising, determining which of the at least one set of the similar elements of the integrated circuit layout that form the at least one column pattern are repetitions of each other.

11. The method of claim 10, wherein generating the description of the at least one column pattern comprises using modal data to indicate column patterns that are repetitions of each other.

12. The method of claim 11, wherein determining which of the at least one set of the similar elements of the integrated circuit layout that form the at least one column pattern are repetitions of each other comprises determining that at least two of the column patterns comprise same number of the like-shaped elements of the integrated circuit layout.

13. The method of claim 9, wherein the at least one column pattern comprises at least some of the similar elements of the integrated circuit layout arranged in the column form with uniform space between vertices of consecutively placed similar elements of the integrated circuit layout forming the column.

14. The method of claim 9, wherein the at least one column pattern comprises at least some of the similar elements of the integrated circuit layout arranged in the column form with non-uniform space between vertices of consecutively placed similar elements of the integrated circuit layout forming the column.

15. The method of claim 9, wherein the description of the at least one column pattern is generated for only those column patterns that comprise at least three similar elements of the integrated circuit layout.

16. A computer implemented method for generating a representation of an integrated circuit layout, the description comprising data related to one or more descriptions of one or more patterns in placement of at least some of the elements within the integrated circuit layout, the method comprising:
identifying at least some similar elements of the integrated circuit layout by processing geometrical data describing at least some of the elements of the integrated circuit layout,
at least based on placement points of origin of at least some of the similar elements of the integrated circuit layout, identifying one or more sets of the similar elements of the integrated circuit layout forming one or more patterns comprising at least some of the similar elements of the integrated circuit arranged in a row-type pattern;
generating a description of the one or more row-type patterns; and
using the description of the one or more row-type patterns to generate the representation of the integrated circuit layout.

17. The method of claim 16 further comprising, determining that at least some sets of the similar elements of the integrated circuit layout forming a row-type pattern are repetitions of each other.

18. The method of claim 17, wherein generating the description of the one or more row-type patterns comprises using modal data to indicate that the at least one of the one or more row-type patterns is a repetition of another.

19. The method of claim 16, further comprising generating the description of the one or more row-type patterns for only those row-type patterns that comprise at least three elements of the integrated circuit layout.

20. The method of claim 16, wherein at least some of the one or more row-type patterns comprise similar elements of the integrated circuit layout having uniform space between consecutive like-shaped elements of the integrated circuit layout.

21. The method of claim 16, wherein at least some of the one or more row-type patterns comprise similar elements of the integrated circuit layout having non-uniform space between consecutively placed similar elements of the integrated circuit layout.

22. The method of claim 16, wherein the elements of the integrated circuit layout are cells.

23. The method of claim 16, wherein the elements of the integrated circuit layout are polygons.

24. A computer implemented method for converting an integrated circuit layout representation from a first format to a second format, the integrated circuit layout representation in the second format comprising data related to one or more descriptions of one or more patterns in placement of elements within the integrated circuit layout, the method comprising:
based on the integrated circuit layout representation in the first format, identifying like-shaped elements of one or more shapes within the integrated circuit layout by processing geometrical data describing at least some of the elements of the integrated circuit layout;
processing placement data in the first format comprising points of origin of at least some of the like-shaped elements to identify one or more sets of the like-shaped elements of the integrated circuit layout arranged in one or more column-type patterns and generating one or more description data structures representative of at least some of the one or more column-type patterns;
processing placement data in the first format comprising points of origin of at least some of the like-shaped elements, identifying one or more sets of the like-shaped elements of the integrated circuit layout arranged in one or more row-type patterns and generating one or more description data structures representative of at least some of the one or more row-type patterns; and
generating one or more description data structures for representing one or more random arrangements of those of the like-shaped elements that are not placed in any of the one or more row-type patterns and the one or more of the column type patterns to generate the integrated circuit representation in the second format.

25. The method of claim 24, wherein the first format is GDSII and the second format is OASIS.

26. The method of claim 24, the first format is OpenAccess and the second format is OASIS.

27. The method of claim 24, wherein the one or more random arrangements of some of the like-shaped elements of the integrated circuit layout comprise at least three like-shaped elements of the integrated circuit layout and at least two of the like-shaped elements are described using displacement coordinates in relation to at least one other of the like-shaped elements also belonging to the random arrangement of like-shaped elements.

28. The method of claim 24, wherein at least some of the elements within the integrated circuit layout are integrated circuit cells.

29. The method of claim 24, wherein at least some of the elements within the integrated circuit layout are polygons.

30. The method claim 24, wherein description data structures for representing row-type patterns comprises modal fields for indicating that one or more of row-type patterns are repetitions of a previously described row-type pattern and a displacement from the previously described row-type pattern.

31. The method claim 24, wherein description data structures for representing column-type patterns comprises modal fields for indicating that one or more of column-type patterns are repetitions of a previously described column-type pattern and a displacement from the previously described column-type pattern.

32. The method claim 24, wherein description data structures for representing random patterns comprises modal fields for indicating that one or more of random patterns are repetitions of a previously described random pattern and a displacement from the previously described random pattern.

33. The method of claim 24, wherein the geometrical data describing shape of at least some of the elements of the integrated circuit layout comprises vertices data of at least some of the elements, height of at least some of the elements and width of at least some of the elements.

34. The method of claim 33, wherein the vertices data is a vector comprising a length data and a direction data.

35. The method of claim 24, wherein the placement data for at least some of the elements of the integrated circuit layout comprises point of origin coordinates of at least some of the elements.
